(19) United States
(12) Patent Application Publication
(10) Pub. No.: US 2007/0016936 A1
(43) Pub. Date: Jan. 18, 2007

(54) Broadcast receiving apparatus

(75) Inventors: Kazuo Okada, Koto-ku (JP); Jun Fujimoto, Koto-ku (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(73) Assignee: Aruze Corp., Koto-ku (JP)

(21) Appl. No.: 11/481,901

(22) Filed: Jul. 7, 2006

(30) Foreign Application Priority Data
Jul. 12, 2005 (JP) 2005-202773

(51) Int. Cl. H04N 7/16; H04N 7/18

(52) U.S. Cl. 725/136; 725/135; 725/81

(57) ABSTRACT

To provide a broadcast receiving apparatus which enables an effective use of information appended to a broadcast, even though a two-direction communication function is not furnished. A broadcast receiving apparatus includes: a memory storing ID data which identifies the broadcast receiving apparatus; an appended information receiver which receives appended information appended to a broadcast from a broadcasting station; a generator which generates code information obtained by encoding the ID data stored in the memory and the appended information received by the appended information receiver; and a transmitter which transmits the code information generated by the generator to a display connected outside.

### RELATED APPLICATION

This application claims the priority of Japanese Patent Application No. 2005-202773 filed on Jul. 12, 2005, which is incorporated herein by reference.

### BACKGROUND OF THE INVENTION

1. Technical Field

The present invention relates to a broadcast receiving apparatus.

2. Related Art

Heretofore, a system where a television signal is transferred via a satellite, such as a broadcast satellite or a communication satellite, and a cable line, and received in each household, has been widely known. A broadcast receiving apparatus (for example, a set top box) for the purpose of enabling viewing of a broadcast from the received television signal, is installed in a residence of a recipient using the system. As well as image data and sound data related to the broadcast, information appended to the broadcast details is included in the television signal received by the broadcast receiving apparatus and, when the recipient operates the broadcast receiving apparatus with a remote controller etc., the appended information is displayed on a television screen as necessary.

Furthermore, in television broadcasts in recent years, it has become possible, using the appended information, to participate in a quiz program being broadcast, or to purchase an item being introduced in a program being broadcast. That is, for example, in the case of the quiz program, an input form for inputting an answer is transmitted included in the television signal as the appended information, the recipient inputs the answer in the input form by operating the broadcast receiving apparatus and, by transmitting the input form to a server etc. of a program compiler, it becomes possible for the recipient to participate in the quiz program. In order to use this kind of two-direction communication function, it has been necessary for the recipient to either install a cable modem etc., for carrying out a data communication via an internet etc., additionally connected to the broadcast receiving apparatus, or to install a broadcast receiving apparatus with a built-in cable modem (for example, Japanese Unexamined Patent Publication No. 2004-254102).

However, a problem has existed that in order to separately install a cable modem etc., for carrying out data communication, it is necessary to secure an installation space. Also, with a broadcast receiving apparatus with a built-in cable modem mentioned in Japanese Unexamined Patent Publication No. 2004-254102, which has been conceived from the space-saving point of view, a recipient who does not use the two-direction communication function frequently has hesitated to purchase due to its high price in comparison with a non-built-in kind apparatus, which causes eventually a problem that the two-direction communication function cannot be used at all.

### SUMMARY OF THE INVENTION

Bearing in mind the problems described heretofore, the invention has been conceived with an aim of providing a broadcast receiving apparatus which enables an effective use of information appended to a broadcast, even though a two-direction communication function is not furnished.

In order to achieve the aim described heretofore, the invention provides the following.

A broadcast receiving apparatus comprising: a memory storing ID data which identifies the broadcast receiving apparatus; an appended information receiver which receives appended information appended to a broadcast from a broadcasting station; a generator which generates code information obtained by encoding the ID data stored in the memory and the appended information received by the appended information receiver; and a transmitter which transmits the code information generated by the generator to a display connected outside.

According to the invention, it is possible to provide a broadcast receiving apparatus which enables an effective use of information appended to a broadcast, even though a two-direction communication function is not furnished.

Additional objects and advantage of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE INVENTION OF THE DRAWINGS

The accompanying drawings, which are incorporated in and constitute a part of the specification, illustrate embodiments of the invention, and together with the general description given above and the detailed description of the embodiments given below, serve to explain the principals of the invention.

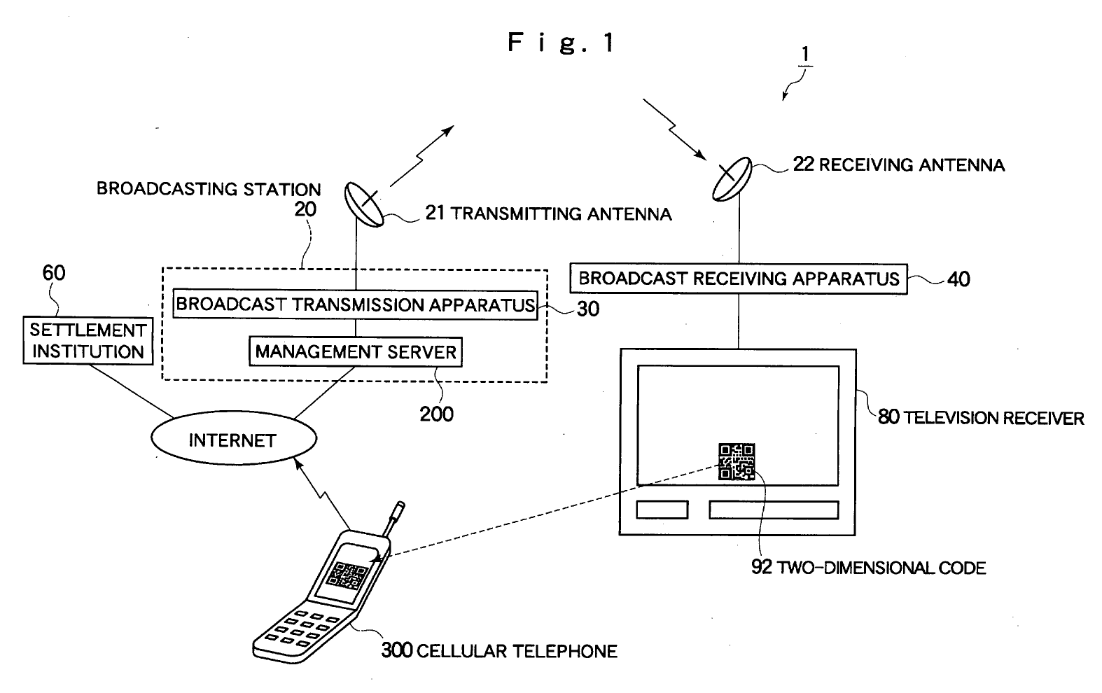

FIG. 1 is a configuration diagram showing an example of a broadcast transmission system according to an embodiment;

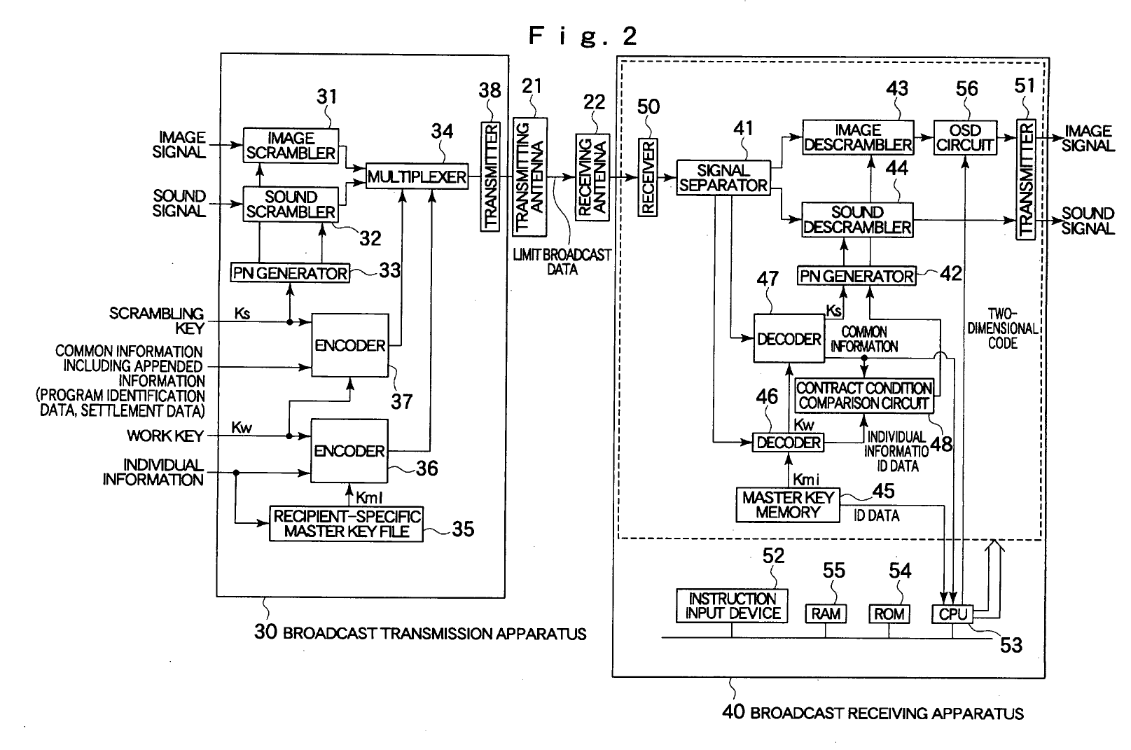

FIG. 2 is a block diagram showing an internal configuration of a broadcast transmission apparatus and a broadcast receiving apparatus shown in FIG. 1;

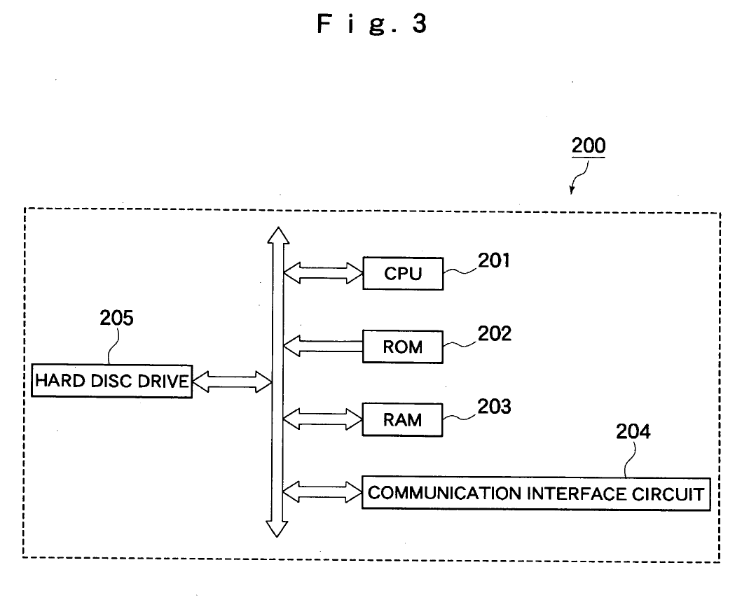

FIG. 3 is a block diagram showing an internal configuration of a management server shown in FIG. 1;

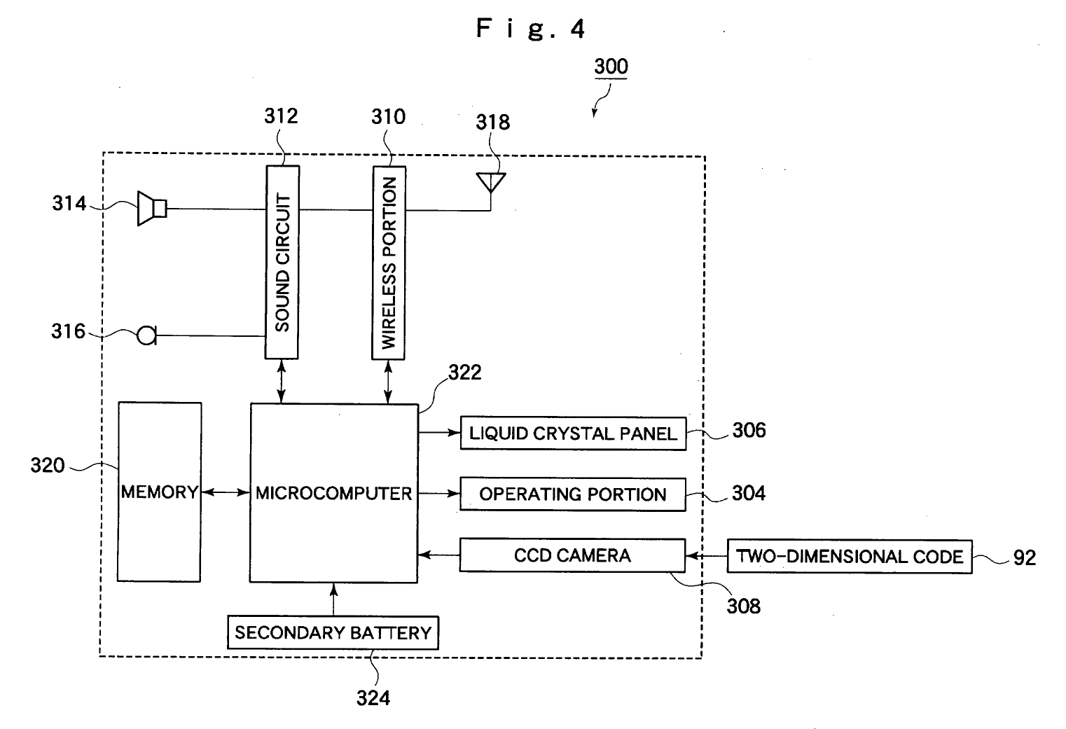

FIG. 4 is a block diagram showing an internal configuration of a cellular telephone shown in FIG. 1;

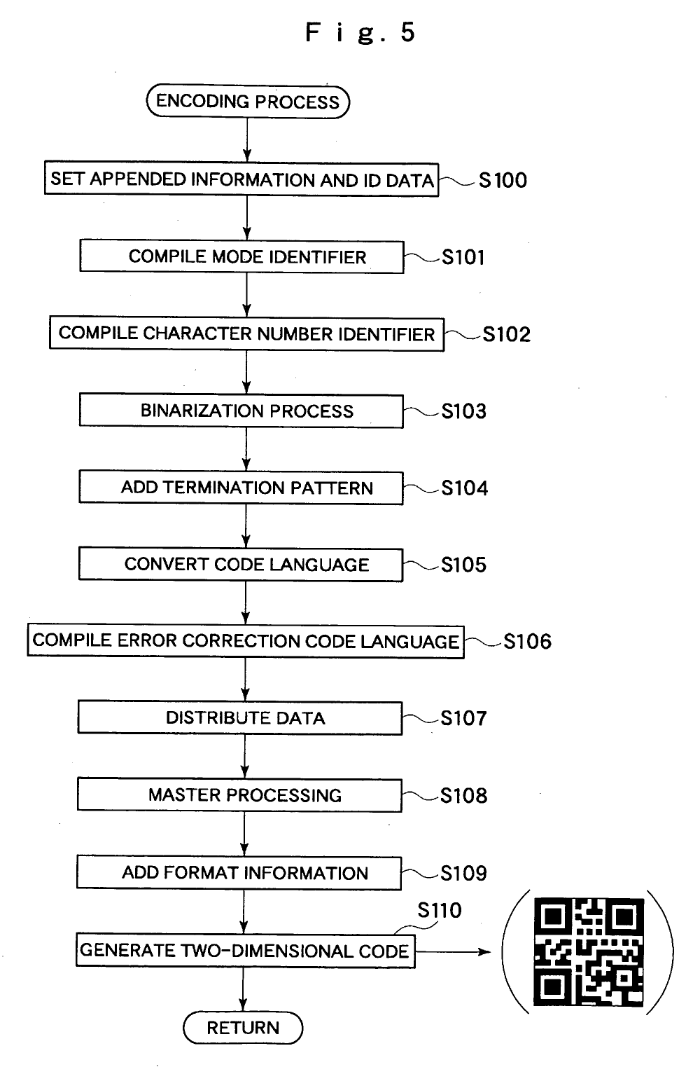

FIG. 5 is a flowchart showing a sub-routine of an encoding process executed in the broadcast receiving apparatus;

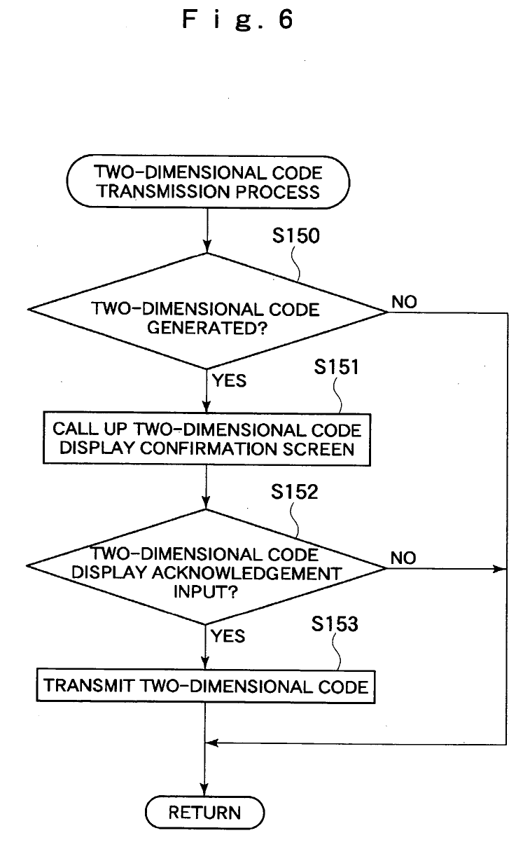

FIG. 6 is a flowchart showing a sub-routine of a two-dimensional code transmission process executed in the broadcast receiving apparatus;

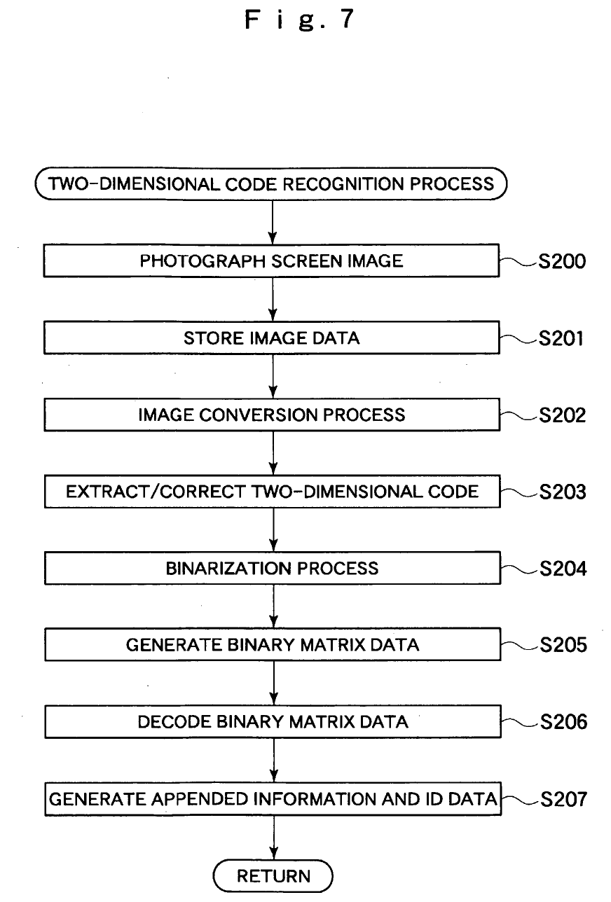

FIG. 7 is a flowchart showing a two-dimensional code recognition process executed in the cellular telephone; and

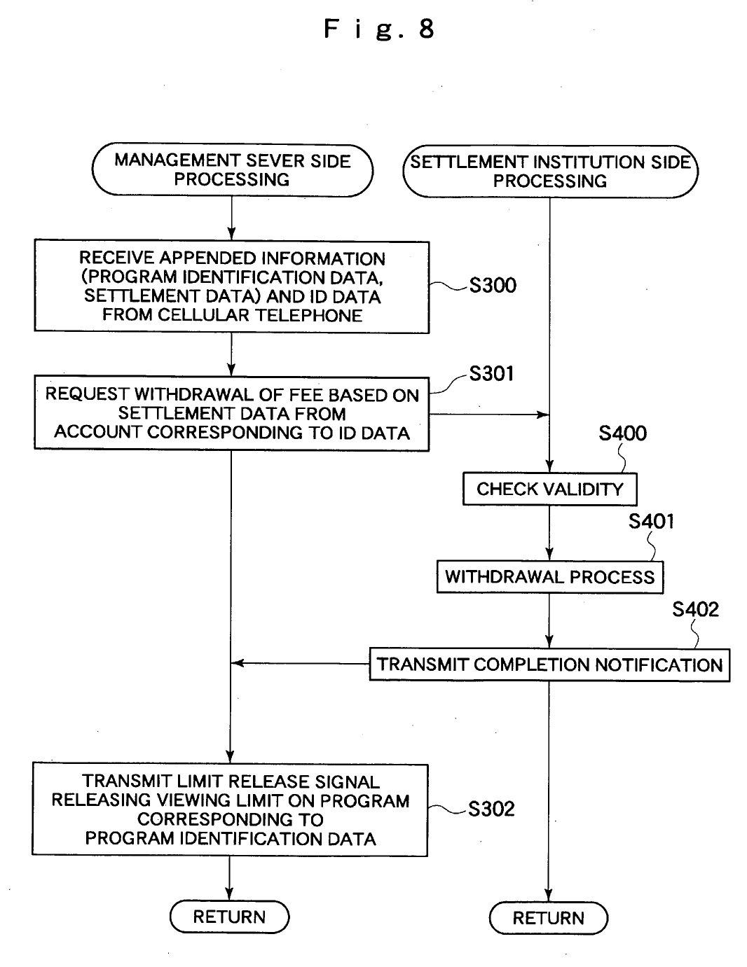

FIG. 8 is a flowchart showing a process executed in the management server and a settlement institution.

### DESCRIPTION OF THE PREFERRED EMBODIMENTS

A broadcast receiving apparatus according to an embodiment comprises a memory storing ID data which identifies the broadcast receiving apparatus, an appended information receiver which receives appended information appended to a broadcast from a broadcasting station, a generator which generates code information obtained by encoding the ID data stored in the memory and the appended information received by the appended information receiver, and a transmitter which transmits the code information generated by the generator to a display connected outside.

According to such a configuration, the code information generated from the ID data which identifies the broadcast receiving apparatus (for example, a set top box) and the appended information received from the broadcasting station is transmitted to the display (for example, a television receiver) connected to the exterior.

As the code information includes the ID data which identifies the broadcast receiving apparatus, it is possible to identify a recipient, meaning that, even though an apparatus equipped with a two-direction communication function is not connected, it is possible to effectively use the appended information. For example, in a case in which the appended information is an input form for inputting an answer for the purpose of participating in a quiz program, the recipient photographs the code information with a camera provided on a cellular telephone or the like, and transmits the ID data generated based on an obtained image data and the input form (the appended information) in which the answer has been input to the server etc., whereby it becomes possible to participate in the quiz program. Also, for example, in a case in which the appended information is an input form for purchasing an item introduced in a program being broadcast, the recipient photographs the code information with a camera provided on a cellular telephone or the like, and transmits the ID data generated based on the obtained image data and the input form (the appended information) in which details of the item to be purchased have been input to the server etc., whereby it becomes possible to purchase the item.

Also, as the code information includes the ID data which identifies the broadcast receiving apparatus, it is possible to identify the recipient, meaning that it is not necessary to input, fill in etc. personal information when the recipient uses the appended information so that it is possible to use the appended information with no attendant inconvenience.

Also, the appended information receiver receives settlement data related to a broadcast viewing fee, wherein the generator can generate the code information, obtained by encoding the ID data stored in the memory and the settlement data received by the appended information receiver.

Using such a configuration, the code information generated from the ID data and the settlement data related to the settlement of the broadcast viewing fee is transmitted to the display connected outside.

As the code information includes the ID data which identifies the broadcast receiving apparatus, it is possible to identify a recipient, meaning that the recipient, by photographing the code information with a camera provided on a cellular telephone or the like, and transmitting the ID data generated based on the obtained image data and the settlement data to the server etc., it is possible to carry out the settlement of the viewing fee (for example, a fixed monthly receiving fee, a program viewing fee set for each program etc.).

Also, by printing or storing in a memory of a cellular telephone etc. the image data (for example, a bar code) obtained by photographing the code information, and having it read by a bar code reader or the like furnished on a register of a convenience store, it becomes possible to carry out the settlement.

Also, the broadcast receiving apparatus described heretofore may be equipped with a built-in display capable of displaying the code information, and in that case, the transmitter can also transmit the code information to the built-in display.

According to such a configuration, as it is equipped with the built-in display, as well as being able to save space, it is also possible to display the generated code information.

Hereafter, a more concrete description of the embodiment of the invention will be given, while referring to the appended drawings. FIG. 1 is a configuration diagram showing an example of a broadcast receiving system according to the embodiment.

A broadcast receiving system 1 comprises a broadcasting station 20, a broadcast receiving apparatus 40, which transmits broadcasting data received from the broadcasting station 20 to a television receiver 80, a cellular telephone 300 equipped with a CCD camera 308 (not shown, refer to FIG. 4), and a settlement institution 60.

In the embodiment, a description is given of a case in which the appended information in the invention includes program identification data and settlement data. The appended information refers to the information appended to the broadcast which is differing from a broadcast image signal. Also, the program identification data refers to the data for identifying the program including, for example, a program name, a program code etc. The settlement data refers to the data used for the settlement of the program viewing fee, including a settlement address (URL) inside a management server 200 and concrete viewing fee data.

The broadcasting station 20 comprises a broadcast transmission apparatus 30 and the management server 200.

Common information such as the appended information, and individual information such as the ID data of the broadcast receiving apparatus 40 are stored in the management server 200. The broadcast transmission apparatus 30 multiplexes the common information and individual information supplied from the management server 200 along with a scrambled image signal and sound signal and transmits it from a transmitting antenna 21 as limit broadcasting data.

The broadcast receiving apparatus 40, on receiving the limit broadcasting data from a receiving antenna 22, separates the signal to the image signal, sound signal, common information and individual information. Then, based on the received common information, individual information and a master key stored in the broadcast receiving apparatus 40, it is determined whether or not the recipient has made a subscription contract for the program, and in the event that it is determined that the subscription contract has been made, the scramble is released and the viewing becomes possible.

Furthermore, the broadcast receiving apparatus 40 generates a two-dimensional code by encoding the received appended information and the ID data stored in the broadcast receiving apparatus 40, and transmits it to the television receiver 80 superimposed with the image signal. When a two-dimensional code 92 is displayed on the television receiver 80, which acts as the display, the recipient can photograph the two-dimensional code 92 with the CCD camera 308 provided on the cellular telephone 300.

The cellular telephone 300 recognizes a two-dimensional code from the image data obtained when the CCD camera 308 photographs the two-dimensional code 92, and generates the appended information and the ID data from the recognized two-dimensional code. Then, it transmits the appended information and the ID data to the management server 200.

The management server 200, on receiving the appended information (the program identification data and the settlement data) and the ID data from the cellular telephone 300, requests the settlement institution 60 to carry out a settlement and, when the settlement is completed, transmits a limit release signal, which releases the viewing limit, to the broadcast transmission apparatus 30.

In this way, according to the broadcast transmission system 1, the recipient, by photographing the two-dimensional code 92 displayed on a screen of the television receiver 80 with the CCD camera 308 provided on the cellular telephone 300, can obtain the appended information and the ID data and, by transmitting it to the management server 200, can release the limit which has been imposed on the viewing of a program. Also, the settlement of the program viewing fee can be carried out.

In the embodiment, a description is given of a case in which the two-dimensional code is used as the code information, but the code information in the invention includes not only the two-dimensional code, but also a one-dimensional code (a bar code). Also, in the embodiment, a description is given of a case in which a QR code (a registered trademark) is used as the two-dimensional code, but the invention is not limited to this example.

The cellular telephone 300 corresponds to a portable terminal in the invention. The portable terminal in the invention, as long as it is equipped with a photographic section and can carry out a transmission and reception of data via the management server and a communication line, is not particularly limited and can include, for example, a personal digital assistant.

Also, in the embodiment, a description is given of a case in which the cellular telephone 300 and the management server 200 carry out the transmission and reception of the data wirelessly, but the invention is not limited to this example as it is also acceptable to carry out the transmission and reception by wire. That is, the transmission line in the invention includes both a wired and a wireless transmission path.

FIG. 2 is a block diagram showing an internal configuration of the broadcast transmission apparatus and the broadcast receiving apparatus shown in FIG. 1.

As shown in FIG. 2, the broadcast transmission apparatus 30 comprises an image scrambler 31, a sound scrambler 32, a PN generator 33, a multiplexer 34, a recipient-specific master key file 35, encoders 36 and 37, and a transmitter 38. Each portion is controlled by a not-shown CPU in accordance with a prescribed program stored in a ROM etc.

First, in the broadcast transmission apparatus 30, when the image signal and sound signal to be broadcast are input into the image scrambler 31 and the sound scrambler 32, respectively, a scrambling process is carried out in accordance with a PN series supplied from the PN generator 33, based on an initial value prescribed by a scramble key Ks.

The PN generator 33 has a circuit which generates a pseudo code series (PN series) based on a prescribed regulation, wherein the initial value is set by the scramble key Ks. The scramble key Ks, which sets the initial value of the PN series used in the image scrambler 31 and the sound scrambler 32, is used for a synchronization with a PN generator 42 furnished on the broadcast receiving apparatus 40. A previously known technology (for example, regarding the image signal, a scan in line signal switch method or a scan line transfer method and, regarding the sound signal, a PN signal series addition method etc.) can be employed for the scrambling process.

In the encoder 37, the scramble key Ks is encoded along with the common information including the appended information (the program identification data and the settlement data) but, at this time, a work key Kw is input into the encoder 37 as an encoding key when the scramble key Ks is transferred, and encoded along with it. The work key Kw is used as the encoding key when the scramble key Ks is transferred. In the broadcast transmission apparatus 30, the common information is transmitted from the management server 200 at a prescribed timing, and encoded by the encoder 37.

However, when the individual information such as the contract details and the ID data of the broadcast receiving apparatus 40 are input into the recipient-specific master key file 35, and a master key Kmi differing for each recipient (each broadcast receiving apparatus 40) is read out, the master key Kmi is input into the encoder 36 as the encoding key, wherein the work key Kw is encoded along with the individual information. The master key file 35 stores a multiple of master keys Km1 to Kmn, wherein one of them, a master key Kmx, is selected according to a selection command from the management server 200. The ID data, being the data which identifies the broadcast receiving apparatus 40, is the data unique to the broadcast receiving apparatus 40. In the broadcast transmission apparatus 30, the individual information is received from the management server 200 at a prescribed timing, and encoded in the encoder 36.

Then, each of the output signals transmitted from the image scrambler 31, the sound scrambler 32 and the encoders 36 and 37, after being input into the multiplexer 34 and multiplexed, is transmitted to each recipient as the limit broadcast data from the transmitting antenna 21 via the transmitter 38.

Also, the broadcast receiving apparatus 40 comprises a signal separator 41, a PN generator 42, an image descrambler 43, a sound descrambler 44, a master key memory 45, decoders 46 and 47, a contract condition comparison circuit 48, a receiver 50, a transmitter 51 acting as the transmitter, an instruction input device 52, a CPU 53, a ROM 54, and a RAM 55.

In the broadcast receiving apparatus 40, when the limit broadcast data is received from the receiving antenna 22 via the receiver 50, each multiplexed signal is separated by the signal separator 41. In this way, the scrambled image signal is input into the image descrambler 43, the scrambled sound signal is input into the sound descrambler 44, the code signal encoded by the encoder 36 is input into the decoder 46, and the code signal encoded by the encoder 37 is input into the decoder 47. The limit broadcast data includes the appended information (the program identification data and the settlement data). The receiver 50 functions as the appended information receiver.

The master key memory 45, being an IC chip installed non-removably inside the broadcast receiving apparatus 40, stores the master key Kmi and ID data unique to the broadcast receiving apparatus 40. The master key memory 45 functions as the memory storing the ID data which identifies the broadcast receiving apparatus 40. In the decoder 46, the work key Km and the individual information in the scrambled broadcast signal received are decoded using the master key Kmi. The decoded work key Kw is input into the decoder 47 as the decoding key. In the decoder 47, the scrambling key Ks and the common information in the scrambled broadcast signal received are each decoded.

The individual information extracted from the decoder 46 and the common information extracted from the decoder 47 are each input into the contract condition comparison circuit 48, where it is determined whether or not prescribed contract conditions are satisfied. In the event that the contract conditions are satisfied, an operation signal is transmitted from the contract condition comparison circuit 48 to the PN generator 42. When the operation signal is input, and a correct scrambling key Ks is input from the decoder 47, the PN generator 42 generates the same PN series as the PN series transmitted from the PN generator 33 of the broadcast transmission apparatus 30, and inputs it into each of the image descrambler 43 and the sound descrambler 44. By this means, the image signal for which the scrambling process has been released is extracted from the image descrambler 43, and the sound signal for which the scrambling process has been released is extracted from the sound descrambler 44.

Also, the CPU 53 generates a two-dimensional code by encoding the ID data stored in the master key memory 45 and the appended information (the program identification data and the settlement data) included in the common information extracted from the decoder 47. The two-dimensional code is transmitted to an OSD (on screen display) circuit 56, whereupon it is synthesized with the image signal transmitted from the image descrambler 43, and transmitted from the transmitter 51. Also, the sound signal transmitted from the sound descrambler 44 is transmitted from the transmitter 51.

The instruction input device 52 is for carrying out the instruction input related to the broadcast reception, such as the switching of the channel and the display of the two-dimensional code. When the two-dimensional code is generated, a two-dimensional code display confirmation screen is displayed, whereby it becomes possible to select the program related to the two-dimensional code. When the recipient selects the program he or she wishes to view from among the programs which have become selectable, the two-dimensional code is transmitted.

The ROM 54 stores the prescribed program for operating the broadcast receiving apparatus 40, control commands for giving the instructions to each portion, etc. The RAM 55, as a temporary memory area of the CPU 53, has a function to store various variables, the generated two-dimensional codes etc.

FIG. 3 is a block diagram showing an internal configuration of the management server of the broadcasting station.

The management server 200 comprises a CPU 201 as a calculation processing device, a ROM 202, a RAM 203, a communication interface circuit 204, and a hard disc drive 205.

The communication interface circuit 204, being capable of communicating with the cellular telephone 300 and the settlement institution 60 via an internet, is also, being connected to the broadcast transmission apparatus 30, capable of carrying out the data transmission.

The appended information (the program identification data and the settlement data) etc. is stored in the hard disc drive 205 as common information. The common information is transmitted to the broadcast receiving apparatus 40, via the communication interface circuit 204, at the prescribed timing, in accordance with the details of the program transmitted from the broadcast receiving apparatus 40.

Also, the contract details of the recipient, the ID data of the broadcast receiving apparatus 40, an account number and a personal name of the settlement institution 60 used by the recipient etc., are stored as individual information in the hard disc drive 205. From the individual information, prescribed information such as the contract details of the recipient and the ID data, is transmitted to the broadcast receiving apparatus 40, at a prescribed timing, in accordance with the details of the program broadcast.

Also, the hard disc drive 205 has an area which correlates and stores the broadcast receiving apparatus 40 ID data, the program identification data and the settlement data received from the cellular telephone 300. The CPU 201, on receiving the ID data, the program identification data and the settlement data from the cellular telephone 300, reads out the account number etc. of the recipient corresponding to the ID data, and requests the settlement institution 60 to withdraw the viewing fee from the account based on the settlement data. In the embodiment, a description is given of a case in which the settlement is carried out based on the account number of the recipient corresponding to the ID data but, without limiting it to this example, it is also acceptable that it is the number of a credit card etc. as, as long as it is possible to carry out the settlement, it is not particularly limited.

Furthermore, the CPU 201, on receiving a withdrawal completion notification from the settlement institution 60, includes the limit release signal (the ID data), which releases the viewing limit of the program corresponding to the program identification data, in the individual information, and transmits it to the broadcast transmission apparatus 30 at the prescribed timing (for example, the timing of the start of the broadcast of the program). As a result, it becomes possible to view the program only on the broadcast receiving apparatus 40 of the recipient corresponding to the limit release signal (the ID data).

Also, the hard disc drive 205 stores a program to be downloaded into the cellular telephone 300. The CPU 201, when receiving a signal from the cellular telephone 300 requesting a download of the program, reads out the program from the hard disc drive 205, and transmits the program from the communication interface circuit 204, via the internet, to the cellular telephone 300.

FIG. 4 is a block diagram showing an internal configuration of the cellular telephone shown in FIG. 1.

The cellular telephone 300 comprises an operating portion 304, a liquid crystal panel 306, a CCD camera 308, a wireless portion 310, a sound circuit 312, a speaker 314, a microphone 316, a transmitting/receiving antenna 318, a non-volatile memory 320, a microcomputer 322 and a secondary battery 324.

The wireless portion 310, being controlled by the microcomputer 322, transmits and receives electric waves as a medium through the transmitting/receiving antenna 318 with respect to a base station. The sound circuit 312, as well as transmitting the received signal transmitted through the microcomputer 322 from the wireless portion 310 to the speaker 314, transmits the sound signal transmitted from the microphone 316 through the microcomputer 322, as a transmission signal, to the wireless portion 310.

The speaker 314 converts the received signal transmitted from the sound circuit 312 into a received sound and transmits it, while the microphone 316 converts a transmission sound generated by an operator into a sound signal and transmits it to the sound circuit 312.

The CCD camera 308 is capable of photographing the two-dimensional code 92 displayed on the screen of the television receiver 80, wherein the image data obtained by the photographing is stored in the non-volatile memory 320. In the embodiment, although a description is given of a case in which the CCD camera is used as the photographic section, the photographic section in the invention is not particularly limited and can include, for example, a CMOS sensor camera etc.

The non-volatile memory 320 non-volatilely stores various data such as, for example, the image data obtained by the CCD camera 308 photographing the two-dimensional code 92, and various programs.

The secondary battery 324 supplies energy to each circuit. The microcomputer 322, comprising a CPU, a ROM and a RAM, carries out, for example, a telephone calling and receiving process, an electronic mail compilation, transmitting and receiving process, an internet process and the like. The microcomputer 322 carries out the transmission and reception of the electronic mail, and the transmission and reception of the data by the internet, via the wireless portion 310 and the transmitting/receiving antenna 318.

The microcomputer 322, based on a prescribed instruction input via the operating portion 304, downloads the prescribed program from the server 200 via the internet, and stores it in the non-volatile memory 320. Then, the microcomputer 322, by reading out the program from the non-volatile memory 320 and executing it, functions as described in A and B hereafter.

A. The microcomputer 322 recognizes the two-dimensional code from the image data obtained when the CCD camera 308 photographs the two-dimensional code 92, and generates the ID data and the appended information from the recognized two-dimensional code.

B. The microcomputer 322 transmits the ID data and the appended information generated in A above, via the internet, to the server 200 by means of the wireless portion 310 and the transmitting/receiving antenna 318.

In the embodiment, although a description is given of a case in which the cellular telephone 300 downloads the program from the server 200, it is also acceptable to have it stored in the non-volatile memory 320 of the cellular telephone 300 in advance (pre-installed).

FIG. 5 is a flowchart showing an encoding process executed in the broadcast receiving apparatus. First, the appended information included in the common information decoded by the decoder 47, and the ID data stored in the master key memory 45, is set (step S100).

Next, a mode identifier is compiled in accordance with a character type (for example, a number, an alpha-numeral etc.) of the appended information and the ID data (step S101). Next, a character number identifier is compiled in accordance with the number of characters of the appended information and the ID data (step S102). Next, a binarization processing of the appended information and the ID data is carried out (step S103). Next, a process is carried out to add a termination pattern to the data obtained from steps S101 to S103 (step S104).

Next, a code language conversion for the data obtained in step S104 is carried out (step S105), and furthermore, an error correction code language is compiled based on the data obtained from step S105 to be added to the data obtained from step S105 (step S106). Next, a process is carried out to binarize the data obtained from step S106 and dispose it in a matrix form (step S107).

Next, a process is carried out to apply a mask of a prescribed pattern to the data obtained from step S107 (step S108). Next, a process is carried out to add format information including an error correction level and a mask identifier is added (step S109) to generate the two-dimensional code (step S110). The generated two-dimensional code is stored in the RAM 55. After that, this sub-routine is completed. In the steps S100 to S110, the broadcast receiving apparatus 40 functions as the generator which generates the two-dimensional code.

In the embodiment, although a description is given of a case in which the appended information and the ID data are encoded into the two-dimensional code, the invention is not limited to this, as it is also acceptable to encode including other data.

FIG. 6 is a flowchart showing the sub-routine of the two-dimensional code transmission process executed in the broadcast receiving apparatus. This sub-routine, unlike the process shown in FIG. 5, is called up and executed at a prescribed timing from a previously executed main routine.

First, it is determined whether or not the two-dimensional code has been generated (step S150) and, if it is determined that it has not been generated, the sub-routine is completed.

Conversely, if it is determined that the two-dimensional code has been generated, the two-dimensional code display confirmation screen is called up in order to confirm whether or not the two-dimensional code is to be displayed (step S151).

Next, it is determined whether or not there has been a two-dimensional code display acknowledgement input (step S152). If there has been the two-dimensional code display acknowledgement input from the recipient via the instruction input device 52, the two-dimensional code stored in the RAM 55 is called up and transmitted (step S153), whereon the sub-routine is completed. Conversely, if there has not been the two-dimensional code display acknowledgement input, the sub-routine is completed.

FIG. 7 is a flowchart showing the two-dimensional code recognition process executed in the cellular telephone.

First, the microcomputer 322 furnished on the cellular telephone 300, based on the instruction input via the operating portion 304, drives the CCD camera 308 which acts as the photographic section, thereby photographing the two-dimensional code 92 displayed on the screen of the television receiver 80 (step S200).

Next, the microcomputer 322 stores the image data obtained from step S200 in the non-volatile memory 320 (step S201).

Next, the microcomputer 322 carries out an image conversion process for the image data stored in the non-volatile memory 320 (step S202). The image conversion process is a process which picks out the area of the image data in which the two-dimensional code is displayed from the image data obtained by photographing, corrects any tilting or distortion, and converts it to a black and white image according to a prescribed threshold, thereby obtaining the image data including the two-dimensional code seen from the front.

Next, the microcomputer 322 extracts the two-dimensional code from the image data obtained from step S202, and carries out the corrections such as a noise removal (step S203).

Next, the microcomputer 322 carries out the binarization processing of the two-dimensional code obtained from step S203, replaces each dot forming the two-dimensional code with a 0 or a 1 (step S204), and generates binary matrix data (step S205). Next, the microcomputer 322 decodes the binary matrix data (step S206), and generates the ID data and the appended data (step S207). After that, the sub-routine is completed.

FIG. 8 is a flowchart showing a process executed in the management server and the settlement institution. First, the management server 200 receives the ID data and the appended data obtained by the two-dimensional code recognition process from the cellular telephone 300 via the internet (step S300).

Next, the management server 200 reads out the account number and personal name of the recipient corresponding to the ID data, and carries out a request to the settlement institution 60 to withdraw the viewing fee based on the settlement data (the appended information) from the account (step S301).

The settlement institution 60, after checking a validity of the request for withdrawal (step S400), such as a compliance etc. of the account number and the personal name, executes the withdrawal process (step 401), and transmits the withdrawal completion notification to the management server 200 (step S402). The settlement institution 60 may include a bank, a credit card company or the like.

The management server 200, on receiving the withdrawal completion notification, transmits the limit release signal, which releases the viewing limit of the program corresponding to the program identification data (the appended data) received in step S300, to the broadcast transmission apparatus 30 at the prescribed timing (for example, the timing of the start of the broadcast of the program) (step S302). As a result, it becomes possible for the recipient to view the program on which the limit of viewing has been imposed.

As described heretofore, according to the broadcast receiving apparatus 40 in the embodiment, the two-dimensional code 92 generated from the ID data and the settlement data (the appended information) is transmitted to the television receiver 80 connected outside.

As the two-dimensional code 92 includes the ID data which identifies the broadcast receiving apparatus, it is possible to identify the recipient, meaning that the recipient, by photographing the two-dimensional code 92 with the CCD camera 308 provided on the cellular telephone 300, and transmitting the ID data generated based on the obtained image data and the settlement data to the management server 200, it is possible to carry out the settlement of the viewing fee (for example, the fixed monthly receiving fee, the program viewing fee set for each program etc.) Consequently, even though an apparatus equipped with a two-direction communication function is not connected, it is possible to effectively use the appended information.

Also, as the two-dimensional code 92 includes the ID data which identifies the broadcast receiving apparatus 40, it is possible to identify the recipient, meaning that it is not necessary to input, fill in etc. personal information when the recipient uses the appended information, so that it is possible to use the appended information with no attendant inconvenience.

Although, in the embodiment, a description is given of a case in which the appended information includes the program identification data and the settlement data, the invention is not limited to this. The appended information in the invention may be, for example, the input form for inputting the answer for the purpose of participating in the quiz program, or the input form for purchasing the item introduced in the program being broadcast. In these cases, it the appended information is the input form for inputting the answer for the purpose of participating in the quiz program, the recipient photographs the code information with the camera provided on the cellular telephone or the like, and transmits the ID data generated based on the obtained image data and the input form (the appended information) in which the answer has been input to the server etc., whereby it becomes possible to participate in the quiz program. Also, for example, it the appended information is the input form for purchasing the item introduced in the program being broadcast, the recipient photographs the code information with the camera provided on the cellular telephone or the like, and transmits the ID data generated based on the obtained image data and the input form (the appended information) in which details of the item to be purchased have been input to the server etc., whereby it becomes possible to purchase the item. In this way, even though an apparatus equipped with a two-direction communication function is not connected, it is possible to effectively use the appended information.

Although, in the embodiment, a description is given of a case in which the two-dimensional code is transmitted to the television receiver 80, the display in the invention is not limited to this example, and may be a display furnished on a personal computer, a projector or the like.

Also, in the embodiment, a description is given of a case in which the two-dimensional code is transmitted to the television receiver 80 connected outside the broadcast receiving apparatus 40, but the invention is not limited to this, and, for example, it is also acceptable that the broadcast receiving apparatus 40 is built into the television receiver 80 which acts as the built-in display. In this case, as the broadcast receiving apparatus 40 is equipped with the built-in display, as well as being able to conserve space, it is also possible to display the two-dimensional code 92.

Although, in the embodiment, a description is given of a case in which the memory is the IC chip installed non-removably inside the broadcast receiving apparatus 40, but the memory may be a ROM, a hard disc or the like. Also, in the embodiment, a description is given of a case in which the IC chip stores the ID data, but it is also acceptable to provide an IC chip reader instead of the IC chip, and store the data on a card with a built-in IC chip etc. inserted from the outside.

Although, in the embodiment, a description is given of a case in which, when the ID data and the appended information are transmitted to the management server 200, the viewing of the program on which the limit of viewing was imposed becomes possible after the settlement is carried out, the invention is applicable to the case that a password on the like is input before carrying out the settlement.

Although, in the embodiment, a description is given of a case in which the appended information is transmitted from the broadcasting station 20, it is sufficient that the appended information in the invention, without being limited to this example, is the information related to the broadcast, for example, it is acceptable that it is the information input from the instruction input device 52 (for example, the program identification data).

Although, in the embodiment, a description is given of a case in which the management server 200 transmits the limit release signal to the broadcast transmission apparatus 30 on condition that the settlement is completed, it is acceptable in the invention that the limit release signal is transmitted even though the settlement is not completed. In this case, by printing or storing in the memory of the cellular telephone 300 etc. the image data obtained by photographing the two-dimensional code, and having it read by the bar code reader or the like furnished on the register of a convenience store, it becomes possible to carry out the settlement.

Heretofore, a description has been given of the embodiment of the invention, but this has only illustrated a concrete example, and in no way limits the scope of the invention, as the design of the concrete configuration of each of the sections etc. can be changed as appropriate. Also, the advantageous effects mentioned in the embodiment of the invention are merely examples of the most suitable advantageous effects arising from the invention, as the advantageous effects of the invention are not limited to those mentioned in the embodiment of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A broadcast receiving apparatus comprising:
a memory storing ID data which identifies the broadcast receiving apparatus;
an appended information receiver which receives appended information appended to a broadcast from a broadcasting station;
a generator which generates code information obtained by encoding the ID data stored in the memory and the appended information received by the appended information receiver; and
a transmitter which transmits the code information generated by the generator to a display connected outside.

2. A broadcast receiving apparatus according to claim 1, wherein
the appended information receiver receives settlement data related to a settlement of a broadcast viewing fee, and
the generator generates code information obtained by encoding the ID data stored in the memory and the settlement data received by the appended information receiver.

3. A broadcast receiving apparatus according to claim 1, comprising a built-in display capable of displaying the code information, wherein
the transmitter transmits the code information to the built-in display.
